(19) United States
(12) Patent Application Publication
(10) Pub. No.: US 2008/0089731 A1
(43) Pub. Date: Apr. 17, 2008

(54) Method and apparatus for using dye-diffusion thermal printing

(76) Inventor: Ezra Szoke, Fremont, CA (US)

Correspondence Address: Jaison C. John;Williams, Morgan & Amerson, P.C., Suite 1100, 10333 Richmond Ave., Houston, TX, 77042, US

(21) Appl. No.: 11/546,630

(22) Filed: Oct. 12, 2006

(51) Int. Cl. B41J 11/04

(52) U.S. Cl. 400/659

(57) ABSTRACT

A method, apparatus and system for performing a dye diffusion printing process, is provided. An apparatus includes a roller for traversing a print medium through a printer. The roller is adapted to provide a rotational force upon a portion of the print medium for advancing a position of the print medium.

### BACKGROUND OF THE INVENTION

1. Field of the Invention

This invention relates generally to printing and, more particularly, to a method, apparatus and system for implementing a dye-diffusion thermal printing process.

2. Description of the Related Art

There have been various advancements in the area of image and text printing technology. Printing images and/or text includes capturing or generating text and image data and processing them for printing. Generally, images and/or text files are downloaded onto a printer using a computer. Various mechanisms are used to guide a print medium, such as paper, across a receptacle of the printer to register an image or text onto the print medium.

Often, data from a computer or other electronic device is sent to a printer, wherein the data is then used to place an image, text, or both onto the print medium by a printer. Some state-of-the-art thermal and ink injection printers generally utilize a method of pulling a print medium through a printer. Other state-of-the-art printers drive the print medium through the printer by wrapping the print medium around a drum or roller. Both methods have some shortcomings. The method involving pulling the print medium through a paper involves mechanism to effectively pull a print medium through a slot in the printer. In using this method, a print roller may be used to assist in guiding the print medium through the printer. This method may provide for using smaller size print rollers or drums, however, the method presents other problems. For example, pulling the paper through the printer may result in registration errors due to slippage between the print medium and the roller. The problems of the registration errors may occur due to slipping of the print medium in relation to the roller. Further, due to the registration errors, multiple passes for printing may result in banding problems.

Other attempts to alleviate problems with the current dye diffusion printer technology include using a high-pinch roller force method. This method involves pinching the print medium using a bottom roller as it is driven through the printer. This method amounts to pulling the paper through the printer, where the roller rotates in a passive manner. The high-pinch roller force can worsen the alignment problem as it is highly dependent on rubber thickness and durometer levels of the lining of the roller. Additionally, damage to the print medium may occur as a result of a large amount of force being applied to the print medium. These methods may result in registration problems due to slipping of the paper in relation to the rotation of the roller.

Another disadvantage of utilizing the printers that use the pulling of the print medium through the printer includes the fact that borders are needed for pulling the paper through the printer. Hence, there would be a region on the print medium on which print material cannot be delivered, thereby forcing the use of a border. For example, in printing photographs, a borderless photograph would be virtually impossible. This may limit various printing applications, such as brochures, photos, etc.

Designers have attempted to alleviate some of these concerns by providing a system wherein the print medium is driven through the printer. For example, the print medium may be driven by a roller such that the print medium wraps around the roller while dye diffusion or thermal processes may be used to print material (e.g., ink) onto the print medium. However, one problem associated with this methodology includes the fact that the size of the roller is dictated by the type of print medium that it is capable of printing. For example, the roller that purports to print an 8×10 print output (e.g., a picture), a larger roller is needed to accommodate the wrapping of the 8×10 print media around the roller. This results in the roller being large, calling for a large casing for the printer. Even for portable printers that are designed to print smaller print output, such as 4×6 photos, etc., the roller is generally large so that the paper can be wrapped around the roller. One such example of such a printer with the shortcoming described above includes a printer offered by Olympus®. Therefore, this design poses problems in reducing the size of the printers since the size is limited to at least the size needed to accommodate a relatively large roller.

The present invention is directed to overcome, or at least reduce, one or more of the problems set forth above.

### SUMMARY OF THE INVENTION

In one aspect of the present invention, an apparatus is provided for performing a dye diffusion printing process. An apparatus includes a roller for traversing a print medium through a printer. The roller is adapted to provide a rotational force upon a portion of the print medium for advancing a position of the print medium.

In another aspect of the present invention, an apparatus is provided for performing a dye diffusion printing process. The apparatus of the present includes a roller for traversing a print medium through a printer. The roller is adapted to provide a rotational force upon a portion of the print medium for advancing a position of the print medium. The roller is also adapted to also provide a directional force to provide contact between the print medium and a film towards a print head.

In yet another aspect of the present invention, an apparatus is provided for performing a dye diffusion printing process. The apparatus of the present invention includes a roller for providing a rotational force upon a print medium and/or a directional force upon the print medium. The directional force provides for causing contact between the print medium and a film, towards a print head. The rotational force provides for modifying a position of the print medium relative to the print head. The roller includes an exterior lining. The lining includes a plurality of particles for providing traction between the roller and the print medium.

In yet another aspect of the present invention, a printing device is provided for performing a dye diffusion printing process. The printing device of the present invention includes a print head unit for delivering a thermal gradient. The printing device also includes a roller for providing movement of a print medium. The roller is also adapted to provide a rotational force upon a portion of the print medium for advancing a position of the print medium.

In yet another aspect of the present invention, a system is provided for performing a dye diffusion printing process. The system includes a data supply unit for providing print data. The system also includes a printing device for a printing device for printing the print data. The printing device includes a print head unit for delivering a thermal gradient. The printing device also includes a roller for providing movement of a print medium. The roller is adapted to provide a rotational force upon a portion of the print medium for advancing a position of the print medium.

In yet another aspect of the present invention, a dye diffusion printing device is provided for performing a dye diffusion printing process. The dye diffusion printing device includes a print head unit for delivering thermal energy. The thermal energy is directed to direct print material from a film onto a print head unit. The roller provides movement of a print medium. The roller provides a rotational force upon a portion of the print medium for advancing a position of the print medium in relation to the print head.

In yet another aspect of the present invention, a method is provided for performing a dye diffusion printing process. The method includes receiving a print medium for printing. The method also includes directing the print medium across a print head by providing a rotational force upon a portion of the print medium using a roller.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a stylized diagram depicting the operation of a printer in accordance with an illustrative embodiment of the present invention;

FIG. 2 illustrates a stylized diagram depicting the operation of a printer in accordance with an alternative illustrative embodiment of the present invention;

FIG. 3 illustrates a stylized three-dimensional depiction of a thermal printer, in accordance with one embodiment of the present invention;

FIG. 4 illustrates a stylized diagram of a printing system that includes various portions of the printer of FIG. 1, in accordance with one illustrative embodiment of the present invention;

FIG. 5 depicts a more detailed illustration of a print head unit of FIGS. 3 and 4, in accordance with one illustrative embodiment of the present invention;

FIG. 6 illustrates an implementation of a roller with the particular implementation of the print head of FIG. 4, in accordance with one illustrative embodiment of the present invention;

FIG. 7 depicts a more detailed illustration of a print head unit of FIGS. 1 and 2, in accordance with an alternative illustrative embodiment of the present invention; and

FIG. 8 illustrates an implementation of a roller with the particular implementation of the print head of FIG. 7, in accordance with an alternative illustrative embodiment of the present invention.

While the invention is susceptible to various modifications and alternative forms, specific embodiments thereof have been shown by way of example in the drawings and are herein described in detail. It should be understood however that the description herein of specific embodiments is not intended to limit the invention to the particular forms disclosed, but on the contrary, the intention is to cover all modifications, equivalents and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Embodiments of the present invention provide for a roller or a drum associated with a printer for driving a print medium through a printer, while providing a directional force or pressure upon the print medium for transferring print material onto the print medium. Embodiments of the present invention provide for an implementation of a print roller to exert force in multiple directions. This force may include a rotational force provided to drive a print medium through the printer, while a directional force may be applied to the print medium in the direction of a print head. The print head, which may be a thermal print head, may then cause material from a film to be placed upon the print medium in a precision manner in reaction to the force applied upon the print head. The directional force may be controlled in such a manner that a predetermined amount of print material may be transferred onto the print medium based upon the particular amount of force applied by the print roller, the time period during which the force is exerted, the frequency of the exerted force upon a particular location on the print medium, and the like.

Utilizing embodiments of the present invention, sufficient contact between the print medium and a portion of the roller is provided to enable the driving of the print medium through the printer. Embodiments of the present invention provide for the ability to drive the print medium through the printer without providing contact between the print medium and substantially the entire surface of the roller. In other words, the printer, in accordance with the embodiments of the present invention is capable of driving the print medium without having to substantially wrap the print medium around the print roller. In one embodiment, the driving of the print medium through the printer may be performed at least during a portion of a time period when sufficient pressure or force against the print head is provided such that a desired amount of print material is transferred onto the print medium. This allows for utilization of rollers with smaller diameter. Embodiments of the present invention provide for implementation of thermal printers, such as dye diffusion printers ink-injection printers, etc., to utilize print rollers of smaller diameters, thereby allowing for smaller profiles of the printers.

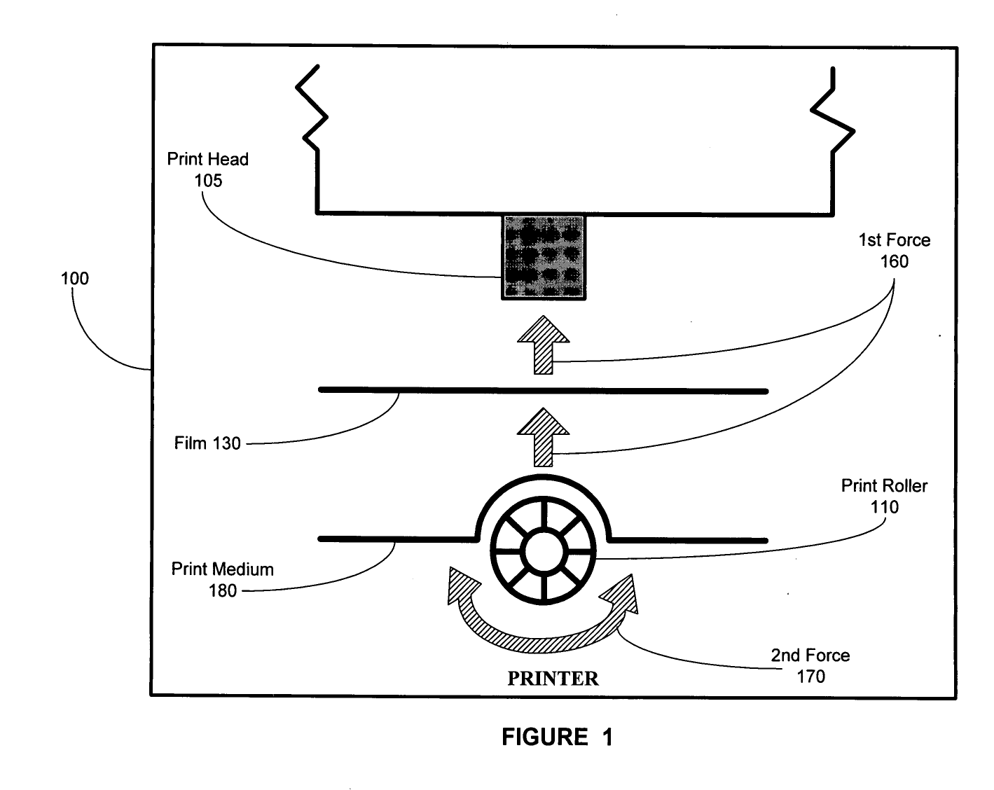

Turning now to FIG. 1, a stylized diagram depicting the operation of a printer in accordance with an illustrative embodiment of the present invention is provided. A printer includes a print roller 110 that is capable of driving a print material 180 through a printer 100. The print medium 180 illustrated in FIG. 1 may include any one of various printable items such as paper, cardboard, other flexible material, or any other medium capable of receiving print material. The print roller 110 is capable of exerting forces in at least two directions as depicted by the arrow 160 (a 1^{st} force 160) and the arrow 170 (a 2^{nd} force 170). As illustrated in FIG. 1, the print medium 180 comes into contact with only a portion of the print roller 110 at any given moment. Therefore, the print medium 180 does not have to be wrapped around the print roller 110 for the driving of the print medium, as well as for appropriate registration of print material onto the print medium 180.

The print roller 110 is also capable of exerting a directional force, i.e., the 1^{st} force 160, upon the print medium 180 and a film 130, towards a print head 105. The print head 105 may be a thermal print head that is capable of providing precision delivery of thermal gradient or thermal energy onto the film 130, which may be in contact with a precise location on the print media 180. Therefore, the print roller 110 is capable of driving the print medium 180 through the printer 100, as well as controlling the transfer of print material through the print medium 180 by providing appropriate force or pressure upon the print medium 180 and the film onto the print head 105. As illustrated in FIG. 1, since the print medium 180 does not have to be wrapped around the print roller 110, the circumference of the print roller 110 may be significantly smaller than the circumference of a roller if it were to be entirely encircled by the print medium 180. Therefore, a relatively small print roller 110 may be used for printing larger sizes of print medium 180, (e.g., 4×6, 5×11, 8.5×11, 16×20, etc).

Using embodiments of the present invention, the profile of the printer 100 may be reduced and yet maintain capability of performing printing processes on a significantly large size of print medium 180. Additionally, since the print medium is being driven substantially entirely by the print roller 110, printing of the print medium 180 may be performed form one end to the other without needing borders or regions where printing is not allowed. For example, the entire area of the print medium 180 may be used to create a photo by printing the photo on the entirety of the print medium 180. Therefore, borderless photos may be generated by the printer 100, while maintaining a relatively small profile of the printer.

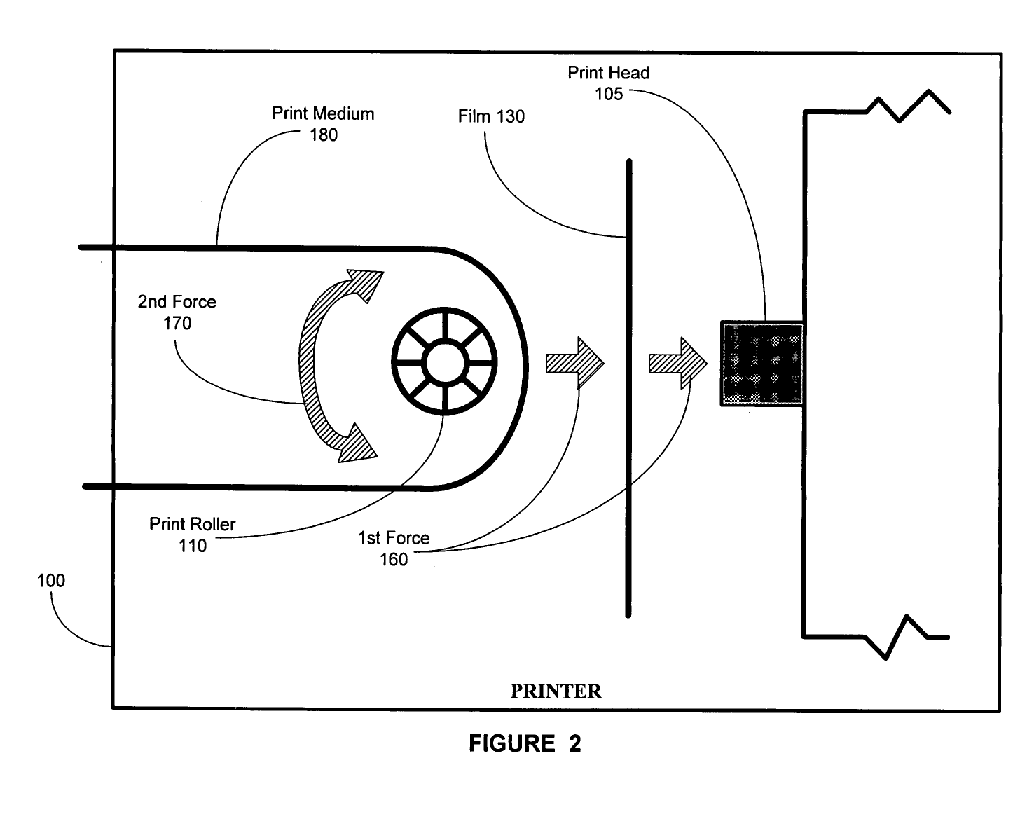

Turning now to FIG. 2, an alternative embodiment of the implementation of the concepts provided by the present invention is illustrated. The implementation illustrated in FIG. 2 may provide for the print medium 180 entering the printer on one side and exiting the printer on the same side. Other embodiments may provide for a configuration where a print medium may enter a first side of the printer and emerge at a second side that is adjacent to the first side of the printer 100. Referring to the embodiment of FIG. 2, the print medium 180 may traverse a path similar to the letter “u” through the printer 100 by utilizing the concepts provided by the embodiments of the present invention. This arrangement may provide for a very small profile of the printer 100.

FIG. 2 illustrates that the print roller 110 provides a rotational force 170 to drive the print medium through the printer 100. In this configuration, a larger percentage of the print medium 180 may be in contact with the print roller 110 at any given moment, as compared to the configuration illustrated in FIG. 1. The print medium 180 forms a “u” shape as it traverses through the printer 100. During at least a portion of the time period when the rotational force 170 is exerted by the roller 110, a directional force 160 may be applied by the roller in the direction of the print head 105. This force (1^{st} force 160) provides a force or pressure to press the print medium onto the film 130 to make contact with the print head 105. Based upon the contact 105, the thermal energy provided by the print head 105 may cause the film 130 to release print material onto the print medium 180. The configuration of FIG. 2 may provide for an approximately 50% wrap around configuration of the print medium 180 around the roller 110. Based upon the 1^{st} force 160, i.e., the directional force 160, the print head 105 may release a controlled amount of print material from the film 130 onto the print medium 180. As the 1^{st} force 160 grows larger, a larger amount of print material may be released from the film onto the print medium 180.

Additionally, the duration of the 1^{st} force 160 may also control the amount or the concentration of the print material 130 that is released onto the print medium 180. Both of the configurations of FIGS. 1 and 2 may provide for multiple passes in a back and forth position off the print medium controlled by the print roller 110. In other words, the rotational force, i.e., the second force 170, may be bidirectional where the print medium may traverse back and forth in the printer. This back and forth movement may coincide with utilization of the same film 130 or a different film of a different color being used during each traverse of the print medium 180 through the printer 100. Therefore, a multiple path process may be provided to extract print material from the film 130 onto the print medium 180.

Utilizing the concepts of driving a print medium 180 by using a print roller, the printer 110 may take on a small profile since a smaller diameter may be used for the print roller 110. Therefore, portable printers 110 may be made possible, yet may be used to print a large variety of print mediums of various sizes. Other configurations involving driving the print medium 180 using the print roller and using directional force to promote a thermal dye diffusion printing process may be used and still remain within the spirit and scope of the present invention.

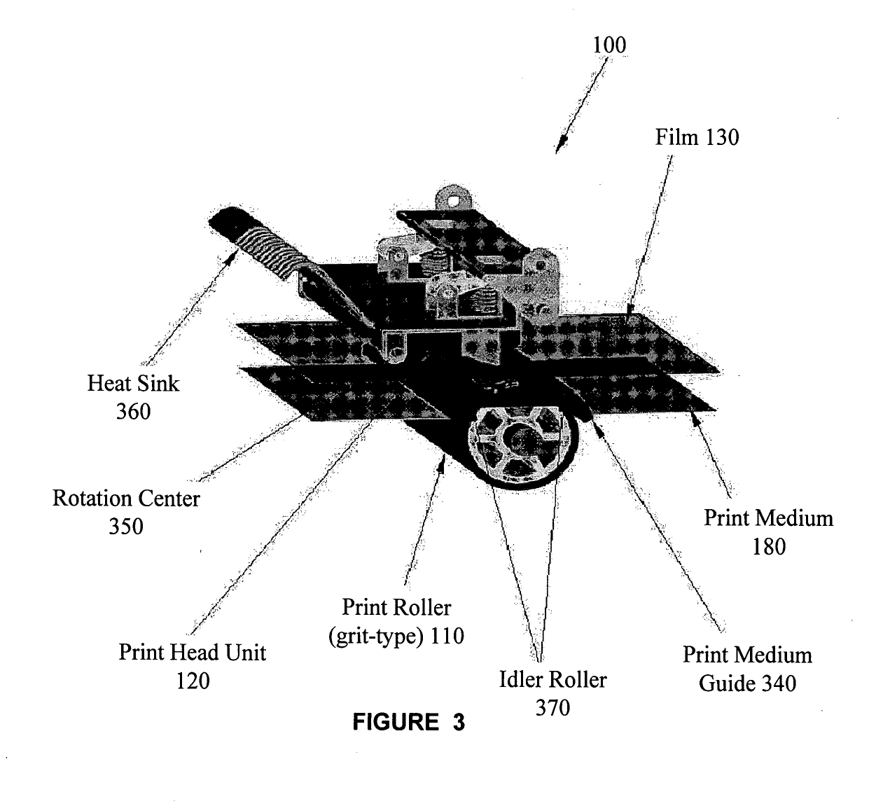

Turning now to FIG. 3, a printer, in accordance with one embodiment of the present invention is illustrated. The printer 100 illustrated in FIG. 3 displays a print medium 180 in a parallel position with a film 130. The print medium 180 illustrated in FIG. 3 may include any one of various printable items such as paper, cardboard, other flexible material, or any other medium capable of receiving print material. FIG. 3 illustrates the print medium 180 being traversed through the printer 100. A print material, such as dye, from the film 130 may be transposed onto the print medium 180. This transposition of the print material may be caused by a force exerted by a print roller 110 that presses the print medium 180 and the film 130 onto a print head unit 120. The print medium 180 may be moved forward and backward through the printer 100 various times with different films 130 in order to transpose various colors onto the print medium 180.

A rotation center 350 provides for facilitating a rotation movement of the roller 110, which causes the paper to traverse through the printer 100. The print roller 110 provides for movement of the print medium 180 along a print medium guide 340. The print medium guide 340 provides assistance to the print roller 110 in traversing the print medium 180 through the printer 100. Additionally, the print roller 110 may provide a force or pressure in causing a contact with the print medium 180 to the film 130, to at least a portion of the print head unit 120. The print head unit 120 provides for delivering heat to appropriate precise locations on the print medium 180 in order to register print material from the film 130 onto the print medium 180.

The print head unit 120 may comprise a plurality of thermal heads (described in subsequent Figures and accompanying description below) to provide for registry of print material from the film 130 onto the print medium 180. The print head unit 120 may comprise a predetermined number of thermal heads spaced at various dots per inch (DPI) configurations. The print head unit 120 may comprise a plurality of thermal heads spaced at a configuration of various dots per inch units, such as the exemplary configurations of 300 DPI, 600 DPI, 900 DPI and a 1200 DPI, 3500 DPI, 1800 DPI, 2400 DPI, 2800 DPI, 3200 DPI, etc. for delivery of print material onto the print medium 180. Those skilled in the art would appreciate that the DPI configurations listed above are for exemplary purposes and not meant as a limitation to the embodiments of the present invention.

The print roller 110 may comprise a silicone material, a ceramic material, etc. The print roller 110 may comprise a lining comprised of various materials, such as rubber. The print roller 110 may also comprise a plurality of particles (i.e., grit) on the rubber to provide for traction. The term “grit” may comprise one or more of a plurality of materials or particles that may be implemented onto the lining of the print roller 110. More detailed description of the grit is provided below.

A heat sink 360 is provided to sink the heat provided by the thermal heads on the print head unit 120. Furthermore, a plurality of idler rollers 370 may provide for rolling and guiding the paper across the printer 100 in conjunction with the print roller 110 in order to provide desirable registry and accuracy of the print material onto the print medium 180. Various electrical signals may be used to control the various thermal heads on the print head. The electrical signal may be used to provide an indication of the amount of time and the temperature involved in delivery of the print material on the film 130 onto the print medium 180.

In one example, a particular print medium 180 may be sent through one or more times through the printer 100 for delivery of print material from various films 130. For example, the print medium 180 may be scanned across the print head unit 110 four times. The first pass of the print medium 180 may involve a yellow film 130. The second pass of the print medium 180 may involve a second time a magneto film. The third pass of the print medium 180 may involve a red film. The fourth pass of the print medium 180 may involve a clear coat film to provide a clear material onto the print medium to enhance the printing results. The amount of force, the amount of heat, and the time period of the force applied to the print head unit 120 may determine the type of print results that may occur. These factors may be controlled electrically to provide control of the print function.

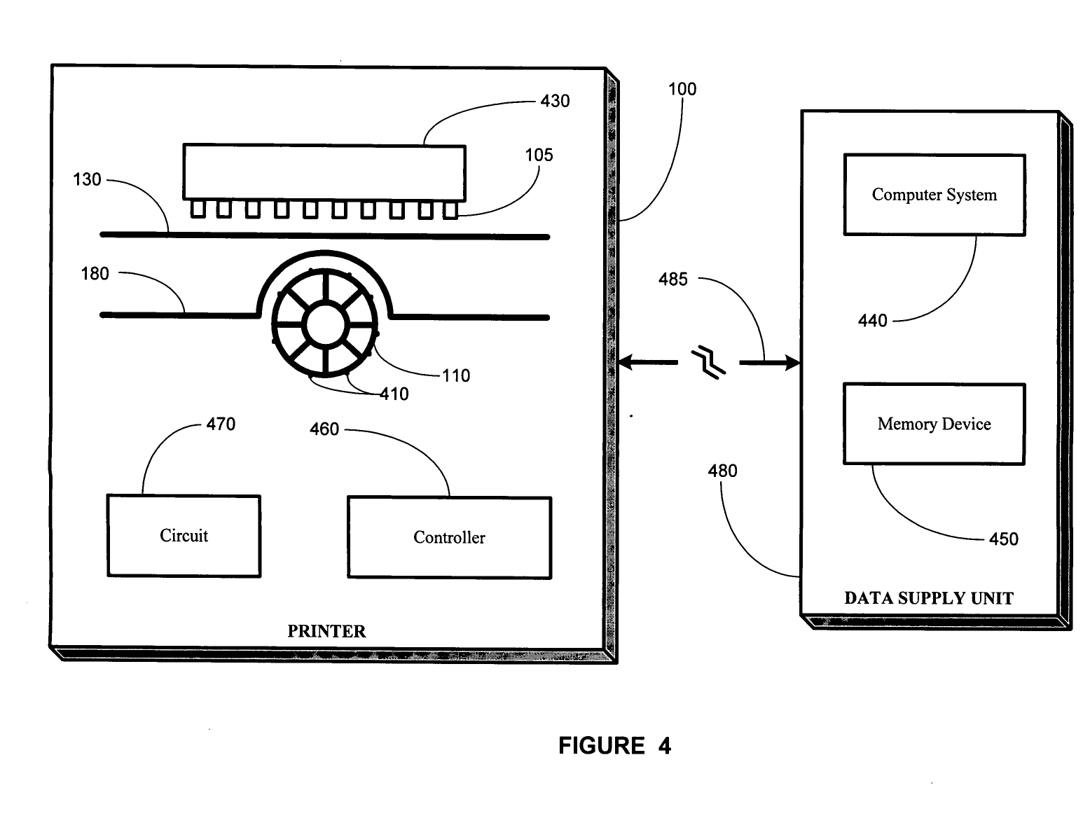

Turning now to FIG. 4, a stylized depiction of a system 200, which includes various components of the printer 110, is illustrated. For clarity of illustration, selected portions of the printer 100 are illustrated. The print head unit 120 and a roller 110 of the printer 100 are illustrated. The printer also comprises a controller 480 capable of controlling various operations of the printer 100. The controller 480 may include processors, memory, and other electronics for facilitating receiving and processing various data signals received by the printer 100. The printer 100 may also comprise a circuit 270 that is capable of receiving electrical signal(s) and providing thermal energy, servo control, and/or other electrical and/or electromechanical operations of the printer 100. The circuit 270 may comprise electrical circuitry to provide for activation and control of the thermal effect provided by the print heads

The system 200 also comprises a data supply unit 280 capable of delivering print content data and/or print command data to the printer 100. In response to the print command data, the controller 480 may execute a printing function based upon the print content provided by the data supply unit 280. The data supply unit 280 may communicate with the printer 100 via a communication line 485. The communication line 485 may be a wired line, such as a network line (e.g., a local area network line [LAN]), a universal serial bus (USB) line, a serial data communication line, a parallel data communication line, a cable communication line, a wireless line, or any type of data communication line.

In one embodiment, the data supply unit 280 may comprise a computer system 440 that is capable of providing print content data and/or print command data to the printer 100. In another embodiment, the data supply unit 280 may comprise a memory device 450 (e.g., a flash memory device, etc.) that is capable of providing print content data to the printer 100. A print function may be initiated by a user by providing a signal to the controller 480 in order to print the print content data. The data supply unit 280 may comprise other electronic devices that may be capable of delivering print content data to the printer 100.

FIG. 4 illustrates a grit material 410 that may be added onto the lining of the roller 110. In one embodiment, the print head unit 120 comprises a print head receptacle 430 that is capable of receiving and holding a plurality of print heads 105. The print heads 105 may be thermal devices capable of delivering precise thermal energy gradients or thermal areas at various DPI configurations described above. The print head receptacle 430 may comprise components such as a heating element for heating individual print heads 105.

The print heads 105 may be spaced upon a predetermined DPI configuration and are capable of accurate registration of print material from the film 130 onto the paper. The print registration may be made possible by the delivery of precise thermal energy by the print heads 105. The thermal energy is delivered to a specific point on the film 130, which may cause transfer of print material from the film 130 onto the print medium 180.

The grit 410 on the print roller 110 may provide traction against the print medium 180 to provide for desirable movement of the print medium 180, which may result in accuracy of registration of print material onto the print medium 180. In one embodiment, the roller 110 is a cylindrical shaped roller that is capable of rotating to grip the print medium 180 and provide force against the print heads 105 for delivery of print material onto the print medium 180. Embodiments of the present invention provide for a novel combination of the type of grit 430 utilized on the print roller 110, in combination with various shapes for the print heads 105. Additionally, embodiments of the present invention provide for a novel combination of the type of grit 410, such as fine grit, along with the types of surface of the print heads 105, in combination with the diameter of the roller to provide for accuracy in registration of a print material onto the print medium 180. The grit 410 on the roller 110 provide for accurate movement of the print medium 180, which may result in the registration of print material from various films 130 during repeated scanning of the print medium 180 through the printer 100.

The grit 410 may be of varying shapes and may have a relatively smooth or coarse surface. The number of grits 410 may be determined by a plurality of factors, such as the type of print medium 180 to be used, the type of film 130 to be utilized, and/or various other factors. The grit 410 may be implemented onto lining material of the roller 110 in such a fashion that it may resemble sand paper. In one embodiment, the size of the grit 410 may be a fraction of the print medium 180, such as approximately 1/10^{th} of the thickness of the print medium 180. In some embodiments, the grit material may be 0.0003 inches. Those skilled in the art having benefit of the present disclosure would appreciate that a variety of patterns, sizes and shapes for the grit 410 may be utilized and remain within the scope and spirit of the present invention. In one embodiment, the grit 410 may provide for a fine grit implementation onto the lining material of the print roller 110. The fine grit implementation of the print roller 110 may present an effectively smooth surface between the paper print medium 180 and the print head 105 at the point of contact. In one embodiment, the fine grit implementation of the present invention provides for desirable accuracy in the registration of the print material onto the print medium and improvements is various operations of the printer 100.

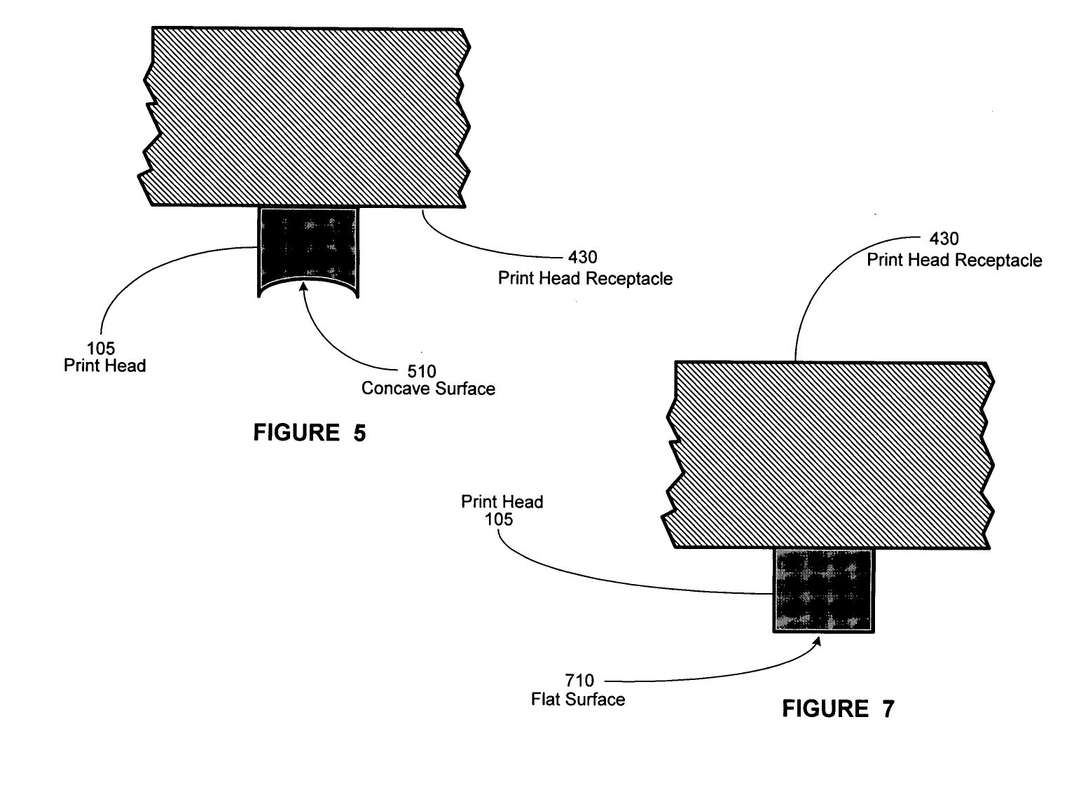

Turning now to FIG. 5, a stylized depiction of one embodiment of the print head unit 120 is illustrated. As illustrated in FIG. 5, the print head receptacle 430 may be attached to the print head 105, which may comprise a concave type surface 510. The concave surface 510 is capable of directing thermal energy substantially even throughout the area along surface 510. The concave surface 510 may be capable of delivering thermal energy unto the film 130 for transferring printing material onto the print medium 180.

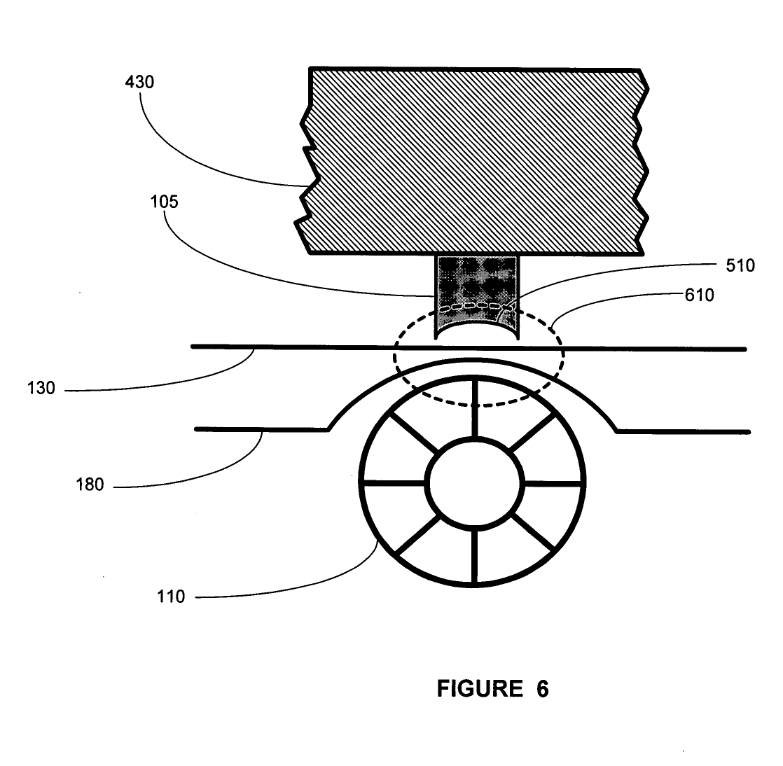

The use of the fine grit and the concave shape surface 510 of the print head 105, in relation with the print roller 110 provides for a geometry that provide for desirable accuracy in the registration of the print material onto the print medium 180. Referring simultaneously to FIGS. 5 and 6, the concave shape of the surface 510 of the print head 105, in conjunction with a predetermined curvature of the print roller 110 provides for predetermined accuracy in the registration of the material from the film 130 onto the print medium 180. As illustrated in FIGS. 5 and 6, the surface 510 print head 105 is shaped in a concave manner such that the curvature of the print roller 110 corresponds to the curvature of the concave surface 510, such that materials from the film 130 are accurately transferred onto the print medium 180. The geometry of the surface 510 of the print head 105 and the print roller 110 provides for an area 510 that provide for a precision intersection of the print head 105, the film 130, the print medium 180, and the print roller 110. The film 130 and the print medium 180 experience a substantially uniform thermal distribution in the area 510. Those skilled in the art having benefit of the present disclosure would appreciate that the illustration in FIGS. 4-7 is not drawn to scale. The illustrations in FIG. 5-7 have been drawn to illustrate that the print heads 105 may be designed to conform to the geometry of the print roller 110.

The area 510 provides for delivery of uniform thermal energy to the film 130, which provides for precision transfer of print material from the film 130 onto the print medium 180. This precision transfer of print materials may also be enhanced as a result of the print medium 180 being accurately pulled through the printer 100 using the grit-type roller 110. Therefore, the grit-type roller 110 is designed in such a shape to match the various print head surface shapes 510 such that from effectively a flat surface is provided at the intersection of the film, the print medium 180, the print head 105, and a portion of the print roller 110. Thereby, the embodiment provided by FIGS. 5 and 6 provides for desirable accuracy of the registration of the print material onto the print medium 180.

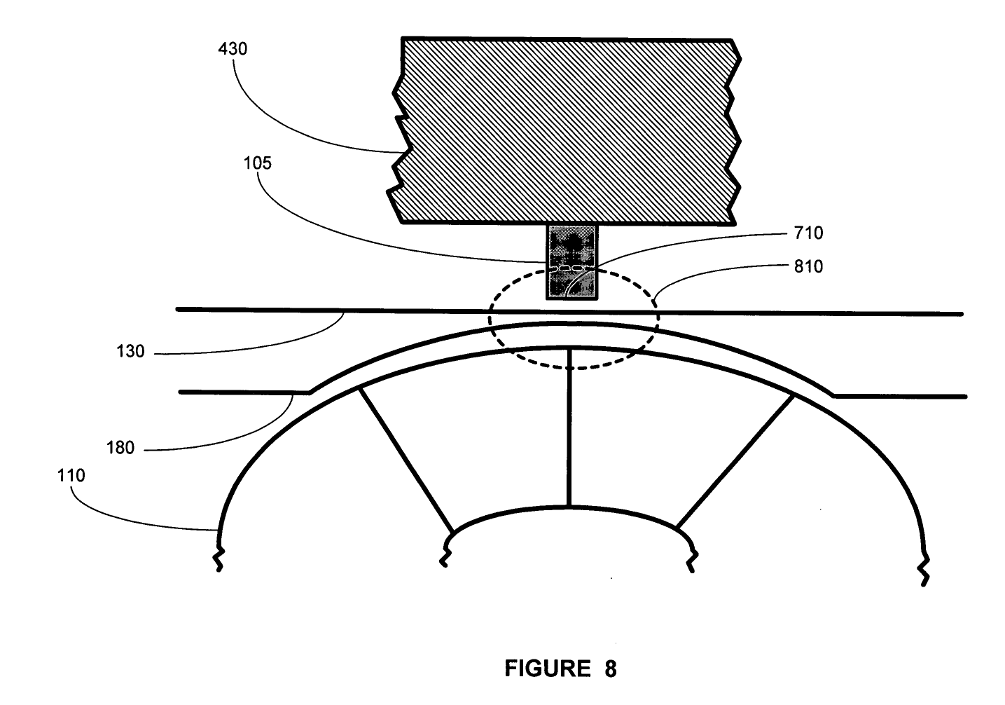

Turning now to FIG. 7, an alternative embodiment of the print head 105 in the print head unit 120 is provided. As illustrated in FIG. 7, the print head receptacle 430 may be attached to the print head 105, which may comprise a flat surface 710. The flat surface 710 is capable of directing thermal energy substantially even throughout the area along surface 510. The flat surface 710 may be capable of delivering thermal energy onto the film 130 for transferring printing material onto the print medium 180.

Referring simultaneously to FIG. 7 and FIG. 8, an implementation of the flat surface 710 in conjunction with a grit roller 110 is illustrated. In the alternative embodiment presented by FIGS. 7 and 8, the interface between the print head 105, the film 130, the print medium 180, and a portion of the print roller 110 provides for a substantially flat area for accurate registration of the print material from the film 130 onto the print medium 180. The flat surface 420 provides for accurate registration of thermal energy onto the film and onto the print medium 180. As illustrated in FIGS. 7 and 8, the surface 510 print head 105 is shaped in a flat manner such that a portion of the curvature of the print roller 110 corresponds to the flat surface 710 of the concave surface 510 such that materials from the film 130 are accurately transferred onto the print medium 180. The geometry of the surface 510 of the print head 105 and the print roller 110 provides for an area 810 that provides for a precision intersection of the print head 105, the film 130, the print medium 180, and the print roller 110. The film 130 and the print medium 180 experience a substantially uniform thermal distribution in the area 810.

The grit type roller 110 provides for accurate movement of the print medium 180 when the shape of the roller 110 is such that at the point of intersection, encircled by the circle label 810, a relatively flat area is available for thermal distribution. The flat area in the circle 810 of the portion of the roller 110 interfaces in a relatively flat manner with the flat surface 710 of the print head 105, thereby delivering a substantially uniform distribution of thermal energy onto the film 130 for transfer of printing medium.

Utilizing the various embodiments provided herein, accurate movement of the print medium 180 through the printer 110 is provided using the grit-type roller in conjunction with the fine grit and the shapes of the print heads surfaces described above along with a predetermined diameter of the rollers 110. Accurate registration of print material from the film 130 onto the print medium 180 is provided. The embodiment illustrated in FIG. 8 may call for a larger print roller, as compared to the embodiment illustrated in FIG. 6. Embodiments of the present invention may also be implemented in various other types of printers that provide for movement of the print material through an area of print material delivery.

A variety of communication protocols may be implemented for the operation of the printer described herein. The embodiments of the present invention may be utilized with a variety of data sources as well as a variety of different types of printers in order to obtain accurate registration of print content.

Embodiments of the present invention provide for utilization of a print roller to drive a print medium through the printer while applying a directional force to provide for transfer of print material onto the print medium. In other words, a roller 110 may be used to drive the print medium, where the print medium 180 is in contact with only a certain percentage of the roller at a given moment. This allows for utilization of a roller with a relatively small diameter. The roller is also capable of providing directional force to provide for thermal energy delivery to precision points of a film to enable precision transfer of print material onto the print medium 180. Various configurations where a partial wrap-around of the print medium 180 on the print roller 110 may be used to provide for traversing the print medium 180 through the print roller of the printer 100.

Utilizing embodiments of the present invention, a lower profile printer may be made possible due to the ability to use a smaller print roller. Therefore, better portable printers may be provided by utilizing the novel configuration of the print roller 110 using embodiments of the present invention. Embodiments of the present invention may be utilized by a print head 105 that may inject print material directly onto the paper for a print head 105 that may provide thermal energy causing transfer of print material from a film 130 onto the print medium 180. Embodiments of the present invention may be utilized for a variety of types of printers.

A variety of communication protocols may be implemented for the operation of the printer described herein. The embodiments of the present invention may be utilized with a variety of data sources as well as a variety of different types of printers in order to obtain accurate registration of print content.

The particular embodiments disclosed above are illustrative only as the invention may be modified and practiced in different but equivalent manners apparent to those skilled in the art who have the benefit of the teachings herein. Further, no limitations are intended to the details of construction or design herein shown other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An apparatus, comprising:
a roller for traversing a print medium through a printer, said roller to provide a rotational force upon a portion of said print medium for advancing a position of said print medium.

2. The apparatus of claim 1, wherein said roller is adapted to apply a directional force to provide contact between said print medium and a film towards a print head.

3. The apparatus of claim 2, wherein said print head is capable of providing thermal energy for transferring print material from said film upon said print medium.

4. The apparatus of claim 1, wherein said roller being capable of moving said print medium in a plurality of directions for applying print material from a plurality of films.

5. The apparatus of claim 1, wherein said print medium is a paper product.

6. An apparatus, comprising:
a roller for traversing a print medium through a printer, said roller to provide a rotational force upon a portion of said print medium for advancing a position of said print medium, said roller to also provide a directional force to provide contact between said print medium and a film towards a print head.

7. An apparatus, comprising:
a roller for providing at least one of a rotational force upon a print medium and a directional force upon said print medium, said directional force for providing contact between said print medium and a film towards a print head, said rotational force for modifying a position of said print medium relative to said print head, said roller comprising an exterior lining, said lining comprising a plurality of particles for providing traction between said roller and said print medium.

8. The apparatus of claim 6, wherein said roller being capable of moving said print medium in a plurality of directions for applying print material from a plurality of films.

9. A printing device, comprising:
a print head unit for delivering a thermal gradient; and
a roller for providing movement of a print medium, said roller to provide a rotational force upon a portion of said print medium for advancing a position of said print medium.

10. The printing device of claim 9, wherein said roller is adapted to apply a directional force to provide contact between said print medium and a film towards a print head.

11. The printing device of claim 9, wherein said printing device is a dye-diffusion printer.

12. The printing device of claim 9, wherein said printing device further comprises a paper guide for guiding said print medium at least through a portion of said printing device.

13. The printing device of claim 9, wherein said printing device further comprises a rotation center for promoting rotation of said roller.

14. The printing device of claim 9, wherein said printing device further comprises a controller to provide control of at least one of said roller and said print head unit.

15. The printing device of claim 9, wherein said printing device further comprises a circuit for controlling an electrical signal for operation of said print head unit.

16. The printing device of claim 9, wherein said printing device further comprises a heat sink for sinking thermal energy.

17. The printing device of claim 9, wherein said print head unit further comprises a plurality of print heads capable of delivering thermal energy at a predetermined area on said film.

18. The printing device of claim 17, wherein said print heads are spaced apart at an arrangement of at least one of 300 dots per inch, 600 dots per inch, 900 dots per inch, 1200 dots per inch, 1500 dots per inch, 1800 dots per inch, 2100 dots per inch, 2400 dots per inch, 2800 dots per inch, and 32 dots per inch.

19. The printing device of claim 17, wherein said print heads further comprise a concave surface to substantially correlate to a curvature of said roller.

20. The printing device of claim 17, wherein said print heads further comprise a flat surface to substantially correlate to at least a portion of said curvature of said roller.

21. A system, comprising:
a data supply unit for providing print data; and
a printing device for printing said print data, said printing device comprising:
a print head unit for delivering a thermal gradient; and
a roller for providing movement of a print medium, said roller to provide a rotational force upon a portion of said print medium for advancing a position of said print medium.

22. The system of claim 21, wherein said data supply unit is at least one of a computer system and a data memory device.

23. The system of claim 21, wherein said print head unit further comprises a plurality of print heads capable of delivering thermal energy at a predetermined area on said film.

24. The system of claim 21, wherein said print heads further comprise a concave surface to substantially correlate to a curvature of said roller.

25. The system of claim 21, wherein said print heads further comprise a flat surface to substantially correlate to at least a portion of said curvature of said roller.

26. A dye diffusion printing device, comprising:
a print head unit for delivering thermal energy, said thermal energy being directed to direct print material from a film onto a print head unit; and
a roller for providing movement of a print medium, said roller to provide a rotational force upon a portion of said print medium for advancing a position of said print medium in relation to said print head.

27. The dye diffusion printing device of claim 26, wherein said roller is adapted to apply a directional force to provide contact between said print medium and a film towards said print head unit.

28. The dye diffusion printing device of claim 26, wherein said print head unit further comprises a plurality of thermal print heads.

29. The dye diffusion printing device of claim 26, wherein said roller is capable of driving said print medium in a bi-directional manner.

30. The dye diffusion printing device of claim 26, further comprising means for driving said print medium by causing said print medium to enter said printing device in the same side where said print medium is directed out of said print device after being processed.

31. The dye diffusion printing device of claim 26, further comprising means for driving said print medium by causing said print medium to enter said printing device in an adjacent side where said print medium is directed out of said print device after being processed.

32. A method, comprising:
receiving a print medium for printing; and
directing said print medium across a print head by providing a rotational force upon a portion of said print medium using a roller.
providing a print head unit for delivering thermal energy, said thermal energy being directed to direct print material from a film onto a print head unit; and
a roller for providing movement of a print medium, said roller to provide a rotational force upon a portion of said print medium for advancing a position of said print medium in relation to said print head.

33. The method of claim 32, further comprising providing a directional force to provide contact between said print medium and a film towards a print head.

34. The method of claim 33, wherein providing said direction force further comprises delivering thermal energy to said film for transferring print material upon said print medium.

35. The method of claim 32, further comprising driving said print medium through said printer a plurality of times to direct transfer of print material to said print medium from a plurality of films.
